(19) United States
(12) Patent Application Publication
(10) Pub. No.: US 2025/0139486 A1
(43) Pub. Date: May 1, 2025

(54) GENERATING A TRANSFORMED DATASET BY QUANTUM TRANSFORMATION OF AN ORIGINAL DATASET AND A QUANTUM FEATURE MAP

(71) Applicant: International Business Machines Corporation, Armonk, NY (US)

(72) Inventors: Brian Leo Quanz, Yorktown Heights, NY (US); Noriaki Shimada, Kawasaki-City (JP); Shungo Miyabe, Minato-ku (JP); Jae-Eun Park, Wappingers Falls, NY (US); Das Pemmaraju, Stockton, CA (US); Chee-Kong Lee, Tacoma, WA (US); Takahiro Yamamoto, Bunkyo-ku (JP)

(21) Appl. No.: 18/497,284

(22) Filed: Oct. 30, 2023

(51) Int. Cl. G06N 10/60

(52) U.S. Cl. CPC G06N 10/60

(57) ABSTRACT

Techniques are described herein regarding utilizing a quantum transformation to generate a transformed dataset from an original dataset and a quantum feature map. For example, one or more embodiments described herein can comprise a system, which can comprise a memory that can store computer executable components. The system can also comprise a processor, operably coupled to the memory, and that can execute the computer executable components stored in the memory. The computer executable components can include operations to transform a qubit of a quantum feature map from an initial state to a transformed state based on an input value of a first classical dataset. The computer executable components can further include operations that generate a second classical dataset based on the input value and the transformed state.

### BACKGROUND

One or more embodiments relate to machine learning, and more specifically, to utilizing quantum computing to generate machine learning datasets.

### SUMMARY

The following presents a summary to provide a basic understanding of one or more embodiments of the disclosure. This summary is not intended to identify key or critical elements, or to delineate any scope of particular embodiments or any scope of the claims. Its sole purpose is to present concepts in a simplified form as a prelude to the more detailed description that is presented later. In one or more embodiments described herein, systems, computer-implemented methods, apparatuses and/or computer program products that can utilize a quantum transformation to generate a transformed dataset from an original dataset and a quantum feature map.

According to some embodiments described herein, a system is provided. The system can include a memory that stores computer executable components. The system can also include a processor, operably coupled to the memory, which can execute the computer executable components stored in the memory. The computer executable components can include a transforming component that can transform a qubit of a quantum feature map from an initial state to a transformed state based on an input value of a first classical dataset. The computer executable components can further include a dataset component that can generate a second classical dataset based on the input value and the transformed state.

In additional, or alternative embodiments, the computer-executable components can further include a training component that can train a classical machine learning model based on the second classical dataset. In additional, or alternative embodiments, the training component can further train the classical machine learning model based on the first classical dataset. In additional, or alternative embodiments, the quantum feature map can include mappings of a first feature of the input value and a second feature of the input value, and the transformed state can include a first observable based on the first feature and a second observable based on the second feature.

In additional, or alternative embodiments, the transformed state can include a stacking of the first observable and the second observable. In additional, or alternative embodiments, the dataset component can generate the second classical dataset based on a first iteration that can transform the second classical dataset based on the first observable, and a second iteration that can transform the second classical dataset based on the second observable.

In additional, or alternative embodiments, the transformed state can include a first transformed state, the qubit can include a first qubit, the quantum feature map can include a first quantum feature map, the input value can include a first input value, the dataset component can generate the second classical dataset further based on a second input value and a second transformed state of a second qubit of a second quantum feature map, and the second transformed state was transformed based on the second input value of the first classical dataset.

In additional, or alternative embodiments, the quantum feature map can be based on the first classical dataset. In additional, or alternative embodiments, the transforming component can transform the qubit of the quantum feature map to the transformed state further based on a Hadamard gate. In additional, or alternative embodiments, the transforming component can transform the qubit of the quantum feature map to the transformed state further based on a phase gate. According to one or more example embodiments, a computer-implemented method is provided. The computer-implemented method can include transforming a qubit of a quantum feature map from an initial state to a transformed state based on an input value of a first classical dataset. The computer-implemented method can further include generating a second classical dataset based on the input value and the transformed state.

In additional, or alternative embodiments, the input value is a first input value, and the training component can further transform the qubit of the quantum feature map from the transformed state to a further transformed state based on a second input value of the second classical dataset, with the dataset component further generating a third classical dataset based on the second input value and the further transformed state.

In additional, or alternative embodiments, the computer-implemented method can further include training a classical machine learning model based on the second classical dataset. In additional, or alternative embodiments, the computer-implemented method can further include training the classical machine learning model based on the first classical dataset. In additional, or alternative embodiments, the quantum feature map can include mappings of a first feature of the input value and a second feature of the input value, wherein the transformed state can include a first observable based on the first feature and a second observable based on the second feature.

In additional, or alternative embodiments, generating the second classical dataset can include a first iteration that transforms the second classical dataset based on the first observable, and a second iteration that transforms the second classical dataset based on the second observable. In additional, or alternative embodiments, the transformed state can include a first transformed state, with the qubit including a first qubit, the quantum feature map can include a first quantum feature map, the input value can include a first input value, generating the second classical dataset is further based on a second input value and a second transformed state of a second qubit of a second quantum feature map, and the second transformed state was transformed based on the second input value of the first classical dataset.

According to other example embodiments, a computer program product that can facilitate utilizing a quantum transformation to generate a transformed dataset from an original dataset and a quantum feature map. The computer program product can include a computer readable storage medium having program instructions embodied therewith. The program instructions can be executable by a processor to cause the processor to transform a qubit of a quantum feature map from an initial state to a transformed state based on an input value of a first classical dataset. In different embodiments, the program instructions can further include instructions to cause the processor to generate a second classical dataset based on the input value and the transformed state.

In additional, or alternative embodiments, the program instructions can further include program instructions to train a classical machine learning model based on the result classical dataset. In additional, or alternative embodiments, the program instructions can further include program instructions to train the classical machine learning model based on the initial classical dataset. In additional, or alternative embodiments, the quantum feature map can include mappings of a first feature of the input value and a second feature of the input value, and the transformed state can include a first observable based on the first feature and a second observable based on the second feature.

Other embodiments may become apparent from the following detailed description when taken in conjunction with the drawings.

### BRIEF DESCRIPTION OF THE DRAWINGS

In certain embodiments, the present invention is described with reference to accompanying figures. The figures provided herein are intended to facilitate a clear understanding of the invention and are not intended to limit the scope or functionality of the invention in any way.

FIG. 1 illustrates a block diagram of an example system that can utilize a quantum transformation to generate a transformed dataset from an original dataset and a quantum feature map, in accordance with one or more embodiments described herein.

FIG. 2 illustrates a block diagram of an example system that can facilitate utilizing a quantum transformation to generate a transformed dataset from an original dataset and a quantum feature map, in accordance with one or more embodiments described herein.

FIG. 3 illustrates a block diagram of an example system that can facilitate utilizing a quantum transformation to generate a transformed dataset from an original dataset and a quantum feature map, in accordance with one or more embodiments described herein.

FIG. 4 illustrates a block diagram of an example system that can facilitate utilizing a quantum transformation to generate a transformed dataset from an original dataset and a quantum feature map, in accordance with one or more embodiments described herein.

FIG. 5 illustrates a block diagram of an example system that can facilitate utilizing a quantum transformation to generate a transformed dataset from an original dataset and a quantum feature map, in accordance with one or more embodiments described herein.

FIG. 6 illustrates a block diagram of an example system that can facilitate utilizing a quantum transformation to generate a transformed dataset from an original dataset and a quantum feature map, in accordance with one or more embodiments described herein.

FIG. 7 illustrates a block diagram of an example system that can facilitate utilizing a quantum transformation to generate a transformed dataset from an original dataset and a quantum feature map, in accordance with one or more embodiments described herein.

FIG. 8 illustrates a flow diagram of an example, non-limiting computer-implemented method that can facilitate utilizing a quantum transformation to generate a transformed dataset from an original dataset and a quantum feature map, in accordance with one or more embodiments described herein.

FIG. 9 depicts an example computer-program product (CPP) that can include executable instructions that, when executed by a processor of a system, can facilitate generating a result classical dataset based on an initial classical dataset and a quantum feature map, in accordance with one or more embodiments.

FIG. 10 includes a computing environment as an example of an environment for the execution of at least some of the computer code involved in performing the methods described herein.

### DETAILED DESCRIPTION

The following detailed description is merely illustrative and is not intended to limit embodiments and/or application or uses of embodiments. As described herein, one or more embodiments can utilize quantum feature transformations to enable a quantum-enhanced version of any classical machine learning algorithm. Furthermore, there is no intention to be bound by any expressed or implied information presented in the preceding Background or Summary sections, or in the Detailed Description section. One or more embodiments are now described with reference to the drawings, with like referenced numerals being used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

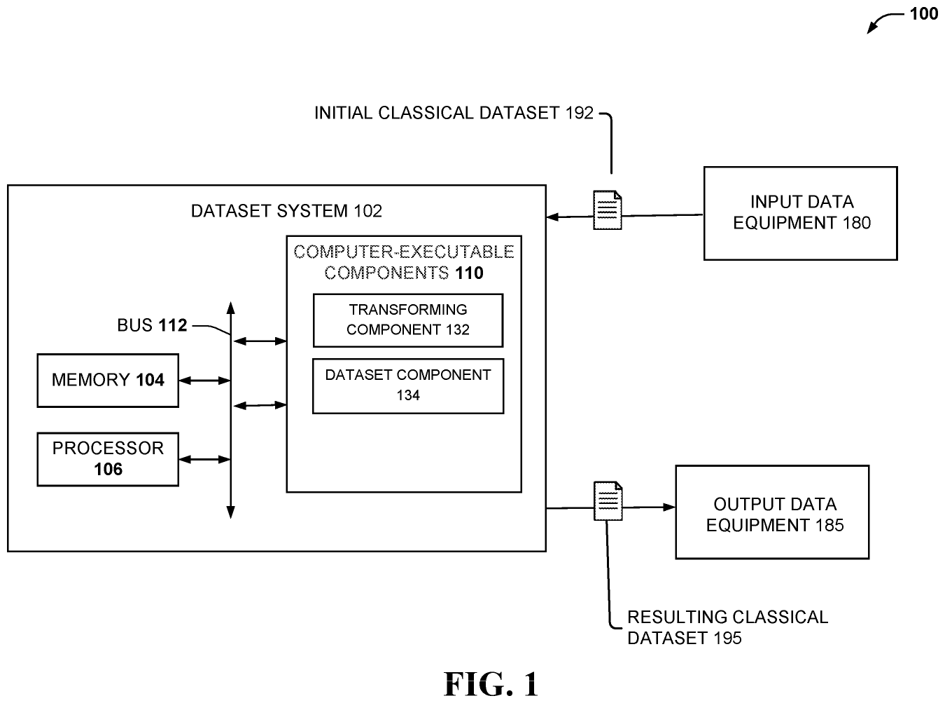

FIG. 1 illustrates a block diagram of an example system 100 that can utilize a quantum transformation to generate a transformed dataset from an original dataset and a quantum feature map, in accordance with one or more embodiments described herein. Embodiments of systems, apparatuses or processes in various embodiments of the present disclosure can constitute one or more machine-executable components embodied within one or more machines, e.g., embodied in one or more computer readable mediums (or media) associated with one or more machines. Such components, when executed by the one or more machines, (e.g., computers, computing devices, virtual machines), can cause the machines to perform the operations described. Repetitive description of like elements and processes employed in respective embodiments is omitted for sake of brevity.

As depicted, system 100 can include dataset system 102 receiving initial classical dataset 192 from input data equipment 180, and producing result classical dataset 195 to output data equipment 185. In some embodiments, dataset system 102 can comprise memory 104, processor 106, and computer-executable components 110, coupled to bus 112.

It should be noted that, when an element is referred to herein as being “coupled” to another element, it can describe one or more different types of coupling. For example, when an element is referred to herein as being “coupled” to another element, it can be described one or more different types of coupling including, but not limited to, chemical coupling, communicative coupling, capacitive coupling, electrical coupling, electromagnetic coupling, inductive coupling, operative coupling, optical coupling, physical coupling, thermal coupling, and another type of coupling.

In one or more embodiments, dataset system 102 can be operated using any suitable computing device or set of computing devices that can be communicatively coupled to devices, non-limiting examples of which can include, but are not limited to, a server computer, a computer, a mobile computer, a mainframe computer, an automated testing system, a network storage device, a communication device, a web server device, a network switching device, a network routing device, a gateway device, a network hub device, a network bridge device, a control system, or any other suitable computing device. A device can be any device that can communicate information with the dataset system 102 and/or any other suitable device that can employ information provided by dataset system 102 and can enable computer-executable components 110, discussed below. As depicted, computer-executable components 110 can include transforming component 132, dataset component 134, and any other components associated with dataset system 102 that can combine to provide different functions described herein.

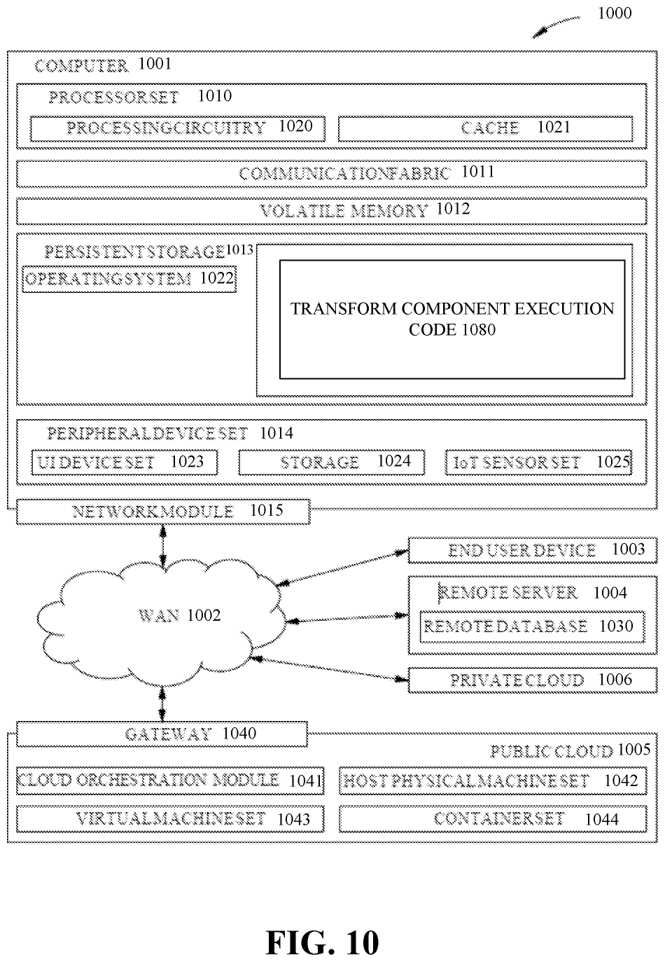

Memory 104 can comprise volatile memory (e.g., random access memory (RAM), static RAM (SRAM), dynamic RAM (DRAM), etc.) and non-volatile memory (e.g., read only memory (ROM), programmable ROM (PROM), electrically programmable ROM (EPROM), electrically erasable programmable ROM (EEPROM), etc.) that can employ one or more memory architectures. Further examples of memory 104 are described below with reference to volatile memory 1012 of FIG. 10. Such examples of memory 104 can be employed to implement any of the embodiments described herein.

In one or more embodiments, memory 104 can store one or more computer and machine readable, writable, and executable components and instructions that, when executed by processor 106 (e.g., a classical processor, and a quantum processor), can perform operations defined by the executable components and instructions. For example, memory 104 can store computer and machine readable, writable, and computer-executable components 110 and instructions that, when executed by processor 106, can execute the various functions described herein relating to dataset system 102, including transforming component 132, dataset component 134, and other components described herein with or without reference to the various figures of the one or more embodiments described herein.

Processor 106 can comprise one or more types of processors and electronic circuitry (e.g., a classical processor, and a quantum processor) that can implement one or more computer and machine readable, writable, and executable components and instructions that can be stored on memory 104. For example, processor 106 can perform various operations that can be specified by such computer and machine readable, writable, and executable components and instructions including, but not limited to, logic, control, input/output (I/O), arithmetic, and the like. In some embodiments, processor 106 can comprise one or more central processing unit, multi-core processor, microprocessor, dual microprocessors, microcontroller, System on a Chip (SOC), array processor, vector processor, quantum processor, and another type of processor. Further examples of processor 106 are described below with reference to processor set 1010 of FIG. 10. Such examples of processor 106 can be employed to implement any embodiments described herein.

As described herein, one or more embodiments can employ hardware and/or software to solve problems that are highly technical, that are not abstract, and that cannot be performed as a set of mental acts by a human. For example, a human, or even thousands of humans, cannot efficiently, accurately and/or effectively perform the complex transformation of quantum circuits described herein, along with different approaches to measuring and processing the results of the quantum transformations.

As discussed below, stored data utilized by one or more embodiments (e.g., initial classical dataset 192 and result classical dataset 195) can be stored in storage that can include, but is not limited to, RAM, ROM, EEPROM, flash memory or other memory technology, solid state drive (SSD) or other solid-state storage technology, Compact Disk Read Only Memory (CD ROM), digital video disk (DVD), Blu-ray disk, or other optical disk storage, magnetic cassettes, magnetic tape, magnetic disk storage or other magnetic storage devices, or any other medium which can be used to store information for embodiments and which can be accessed by the computer.

As depicted, memory 104, processor 106, transforming component 132, dataset component 134, and any other component of dataset system 102 described or suggested herein, can be communicatively, electrically, operatively, and optically coupled to one another via bus 112, to perform functions of dataset system 102, and any components coupled thereto. Bus 112 can comprise one or more components including, but not limited to, a memory bus, memory controller, peripheral bus, external bus, local bus, a quantum bus, and any other type of bus that can employ various bus architectures. Further examples of connections similar to bus 112 are described below with reference to computer 1001 of FIG. 10. Such examples of bus 112 can be employed to implement any of the embodiments described herein.

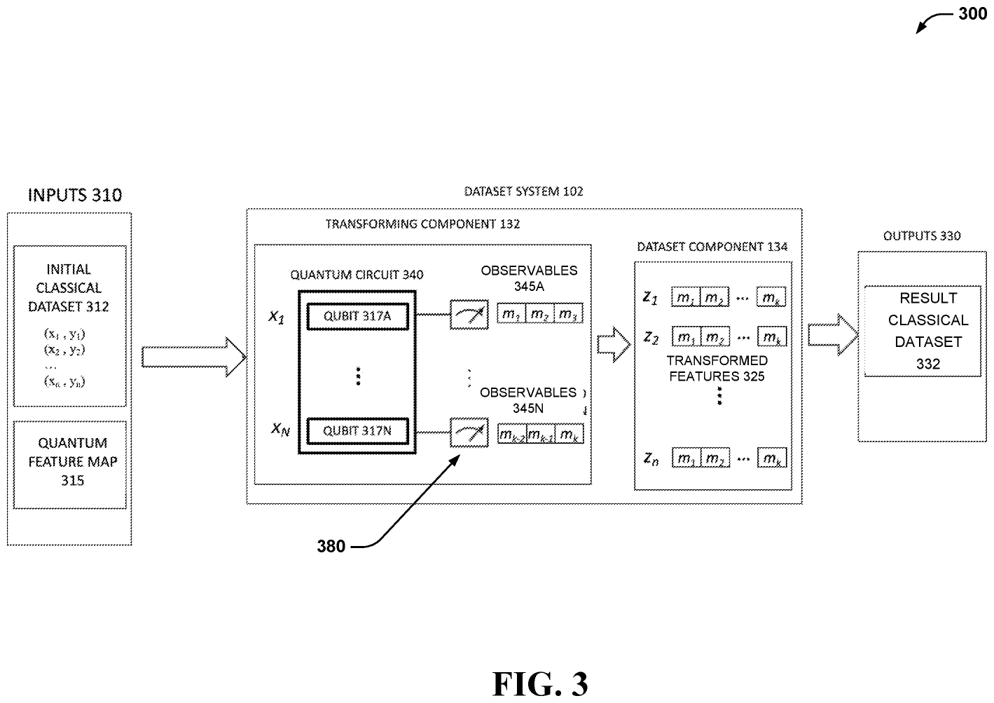

In one or more embodiments described herein, dataset system 102 can utilize transforming component 132 to perform (e.g., via processor 106) operations including, but not limited to, operations to transform a qubit of a quantum feature map from an initial state to a transformed state based on an input value of an in initial classical dataset. In additional embodiments described herein, dataset system 102 can utilize dataset component 134 to perform (e.g., via processor 106) operations including, but not limited to operations to generate a second classical dataset based on the input value and the transformed state. Additional description of example operations that can be performed by transforming component 132 and dataset component 134 are included with the descriptions of FIGS. 3-7 below.

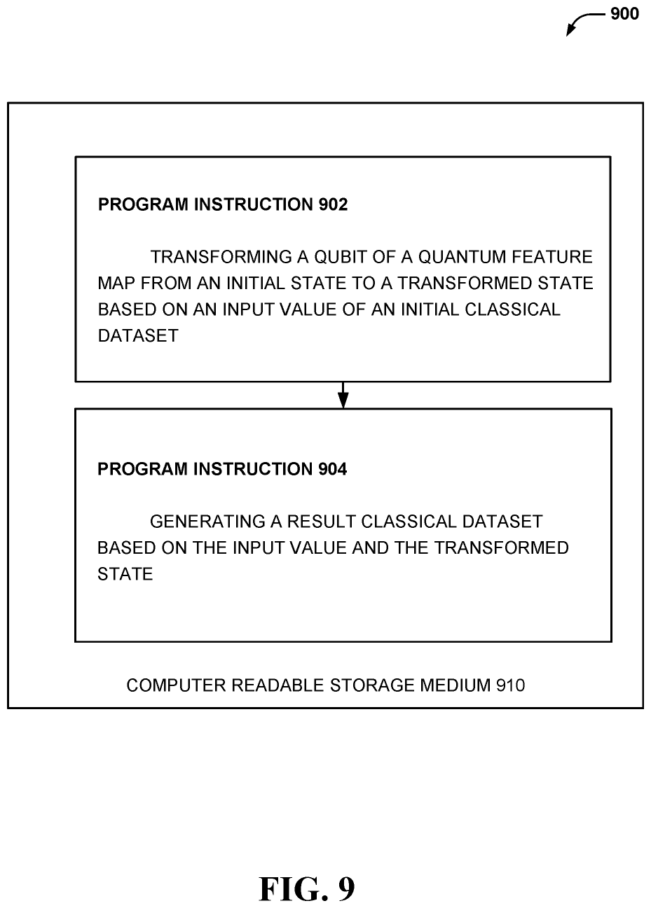

It should be appreciated that the embodiments described herein depict in various figures disclosed herein are for illustration only, and as such, the architecture of such embodiments are not limited to the systems, devices, and components depicted therein. For example, in some embodiments, dataset system 102 can further comprise various computer and computing-based elements described herein with reference to sections below such as FIG. 9. In various embodiments, components of the dataset system 102 (such as transforming component 132 and dataset component 134) can include functional elements that can be implemented via cloud technologies, physical components (for example, computer hardware) and local software (for example, an application on a mobile phone or an electronic device).

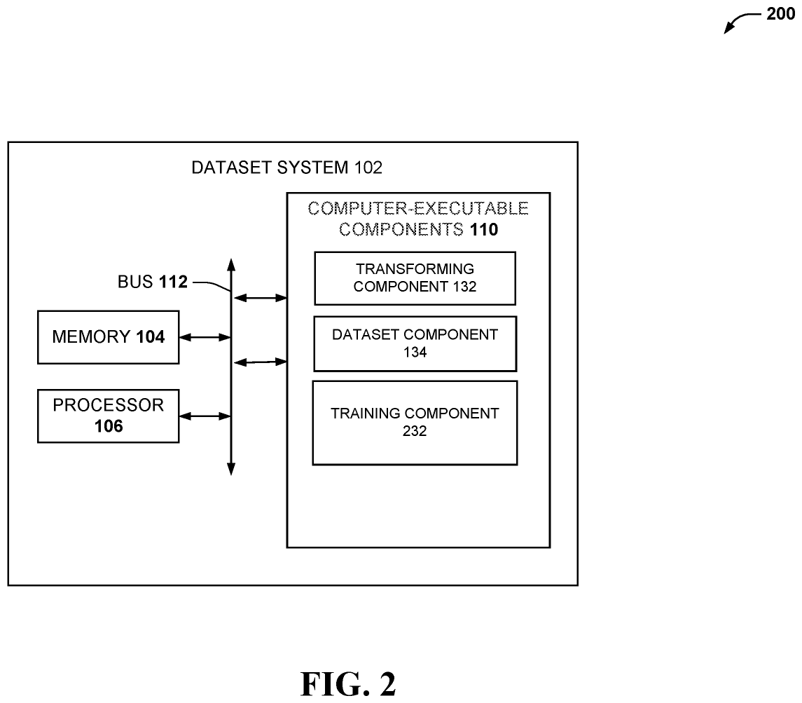

FIG. 2 illustrates a block diagram of an example system 200 that can facilitate utilizing a quantum transformation to generate a transformed dataset from an original dataset and a quantum feature map, in accordance with one or more embodiments described herein. Repetitive description of like elements employed in one or more embodiments described herein is omitted for sake of brevity.

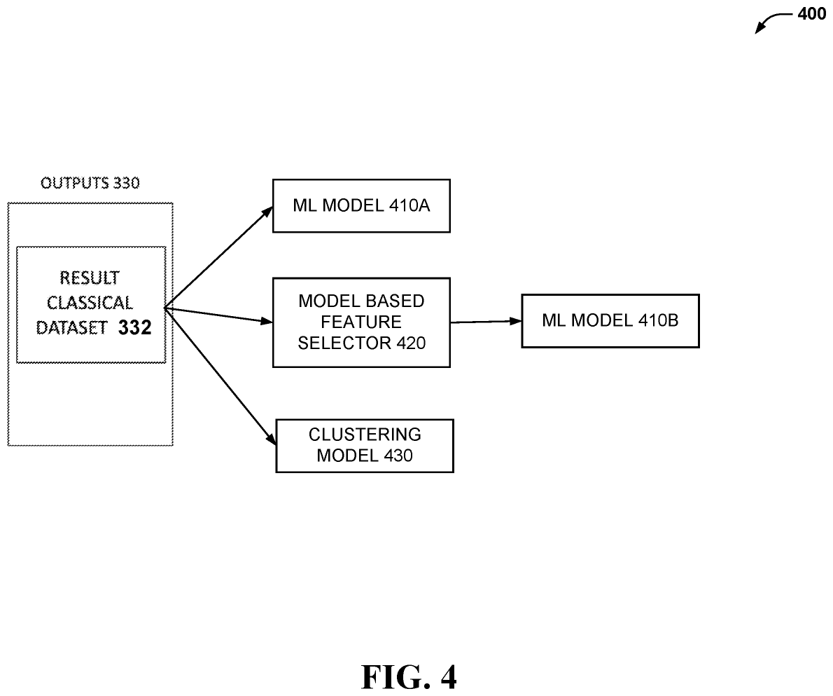

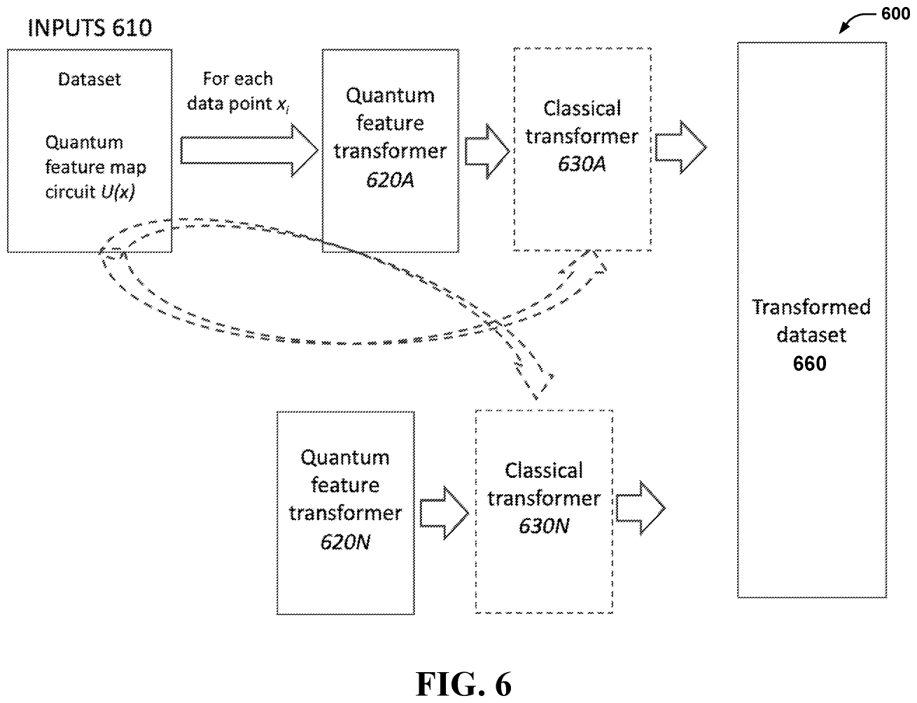

As depicted, system 200 includes the components of dataset system 102 described in FIG. 1, with the addition of training component 232 to computer executable components 110. In one or more embodiments described herein, example system 200 can utilize training component 232 to perform (e.g., via processor 106) operations including, but not limited to, training a classical machine learning model based on the second classical dataset. Addition discussion of the training of classical machine learning models is included with the description of FIGS. 4 and 6 below.

FIG. 3 illustrates a block diagram of an example system 300 that can facilitate utilizing a quantum transformation to generate a transformed dataset from an original dataset and a quantum feature map, in accordance with one or more embodiments described herein. Repetitive description of like elements employed in one or more embodiments described herein is omitted for sake of brevity.

System 300 can include inputs 310 provided to dataset system 102, which generates outputs 330 therefrom. Inputs 310 can include initial classical dataset 312 and quantum feature map 315, and outputs 330 can include result classical dataset 332. As depicted, dataset system 102 can include transforming component 132 coupled to dataset component 134. Transforming component 132 can include quantum circuit 340, transition observing component 380, and transformed features 345A-N. In one or more embodiments, quantum circuit 340 can include qubits 317A-N.

As depicted, an example implementation, a first classic machine learning model or data generating process can result in an initial classical dataset 312, e.g., (x₁, y₁) . . . (xₙ, yₙ), where each xᵢ can include of one or more values. In some implementations, initial classical dataset 312 can be created by collecting data from some system, e.g., as an initial step in a machine learning process. In a non-limiting example, an initial classical dataset 312 can be created by processing a collection of images to yield a representation of the image pixel values, and labels can be assigned to the pixel values.

Continuing this example, once created, initial classical dataset 312 can be used to generate quantum feature map 315. In this example, quantum feature map 315 can be implemented as quantum circuit 340, e.g., comprised of qubits 317A-N. In one or more embodiments, a different quantum circuit 340 can be implemented for particular input values (e.g., x₁ . . . xₙ), and these input values can be used to transform respective qubits 317A-N from their initial states, e.g., by transforming component 132 of dataset system 102. Stated differently, quantum circuit 340 represents a quantum feature map, or transformation of the original classical feature input values, and input values can be used to extend and take projected, or measured, values from the resulting quantum state, as a quantum feature transformation, e.g., transformed feature measurements termed observables 345A-N. As depicted m₁ . . . m₃ are measurements of the transformed input values x₁ . . . xₙ for measurements 1-3 of quantum feature map 315.

In a non-limiting example implementation, quantum circuit 340, operating as a quantum feature map, can map a given input (e.g., x₁) to the quantum state, e.g., by changing the circuit based on the values of x₁, this also being termed a parameterized circuit. For example, x₁ may have values 1.4, 1.2, and 0.7, and based on these values for x₁ and quantum circuit 340 (e.g., a particular quantum feature map/parameterized circuit), one or more embodiments can transform the initial quantum state with the feature map circuit and the particular input (x₁) by applying Y-rotation operations to qubit 1 with angle 1.4, qubit 2 with angle 1.2, and qubit 3 with angle 0.7. Continuing this example, x₂ can have three different values than x₁ and thus, one or more embodiments can further transform the initial quantum state of quantum circuit 340 by applying the corresponding rotations with the different values of x₂. e.g., performing the quantum feature mapping for x₂. As described below, once one or more embodiments have transformed the initial quantum state with the feature map circuit and the particular inputs (x₁, x₂) then observables 345A-N (projections) of the quantum state can be measured to determine the transformed features 325.

To yield a new set of classical features (e.g., result classical dataset 332), dataset component 380 can approximate the quantum state of qubits 317A-N by analyzing measurements and generating observable measurements, e.g., observables 345A-N. These measurements are then combined by component 134, e.g., by stacking together all measurements, to form new features per data point, e.g., transformed features 325 z₁ . . . z_{N}. In this example, the zᵢ values correspond to a quantum transformed version of the xᵢ values, for all i from 1 to n, and in different implementations, this approach can be applied to any approximation of a quantum state computed from measurements, e.g., expectations of specific observables and/or quantum state shadows can be collected.

Continuing this example, in one or more embodiments, the mx values can be combined (e.g., stacked) for each zᵢ value and yield result classical dataset 332 that maps (xᵢ, yᵢ) to (zᵢ, yᵢ) for all i. Additionally, or alternatively, the mx values can be combined for each zᵢ value resulting in result classical dataset 332 that maps (xᵢ, yᵢ) to (zᵢ, xᵢ, yᵢ). Thus, in one or more embodiments, result classical dataset 332 can be described as a new set of classical features that capture some key information for approximating the quantum states of quantum circuits 340. As described with FIG. 4 below, because a classical machine learning model can be directly applied to result classical dataset 332, one or more embodiments can avoid the process of converting the classical machine learning model to a quantum circuit.

In additional, or alternative embodiments, result classical dataset 332 can be used for multiple quantum transformations in sequence. For example, after generation of result classical dataset 332 by dataset component 134, training component 132 can utilize result classical dataset 332 to further transform qubit 317A of quantum circuit 340 from the transformed state to a further transformed state, and dataset component 134 can further generate a second result classical dataset based on the result classical dataset 332 and the further transformed state.

In additional, or alternative embodiments, modeling using multiple, different quantum and classical transformations can be combined in different ways, e.g., by using a boosting or tree-based model to combine predictions of models based on different transformed datasets in different ways, such as with a weighted sum using specific weights, or via using an additional classical model. In another example, one or more embodiments can apply quantum feature transformations after classical transformations, e.g., by subsampling features, so that implicit feature selection can be performed.

FIG. 4 illustrates a block diagram of an example system 400 that can facilitate utilizing a quantum transformation to generate a transformed dataset from an original dataset and a quantum feature map, in accordance with one or more embodiments described herein. Repetitive description of like elements employed in one or more embodiments described herein is omitted for sake of brevity.

System 400 includes different machine learning models being applied to result classical dataset 332 of outputs 330, e.g., ML model 410A applied directly, ML model 410B being applied after processing with model-based feature selector 420, and clustering model 430. In these examples, the results of the quantum feature transformation applied to input features results in a new set of quantum-based classical features, and/or feature selection, that can be utilized outside of quantum processing structures, e.g., efficiently and practically avoiding the complexity of quantum processing and measurement.

For example, because the above described approaches compute a set of expectations, e.g., of single-qubit observables, to use as features less circuit runs and potentially less shots are required, resulting in better error mitigation and tolerance to noise, and shorter quantum circuit depth. Stated differently, in some circumstances, high quantum circuit noise can result in noisy and inaccurate quantum machine learning outcomes, or noisy features, with embodiments reducing the likelihood of this outcome. In some circumstances, these approaches can make meta-modeling much more tractable as well, e.g., enabling directly performing feature selection on the transformed features without requiring the use of additional quantum circuits.

In addition, different approaches described herein can facilitate the use of new ways of combining quantum machine learning with classical machine learning, such as using both classical and quantum features, and selecting/transforming from both classical and quantum features simultaneously. For example, in one or more embodiments, quantum derived features (e.g., transformed features 325) can be used to generate result classical dataset by combining (z₁, y₁) . . . (zₙ, yₙ) with (x₁, y₁) . . . (xₙ, yₙ), e.g., by concatenating the one-or-more features contained in each of zᵢ and xᵢ.

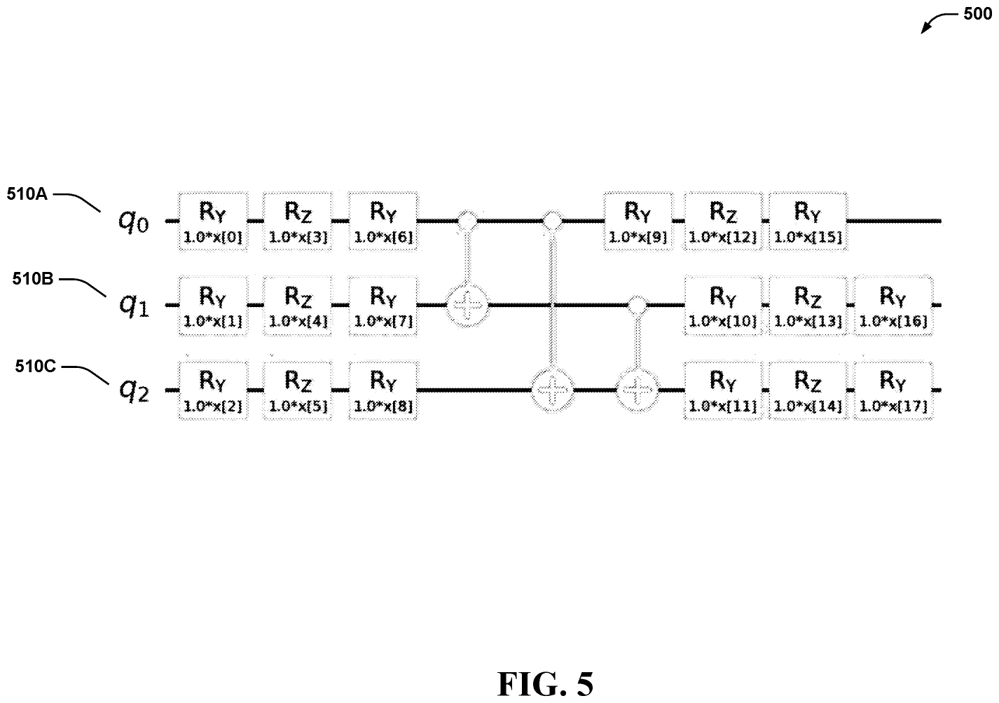

FIG. 5 illustrates a block diagram of an example system 500 that can facilitate utilizing a quantum transformation to generate a transformed dataset from an original dataset and a quantum feature map, in accordance with one or more embodiments described herein. Repetitive description of like elements employed in one or more embodiments described herein is omitted for sake of brevity.

In one or more embodiments, the approaches described herein can result in a combination with dense encoding, e.g., encoding that can utilize fewer qubits than a number of features by applying multiple different quantum circuit operations for different features in sequence, that can enable different approaches to scaling/applying to real data. As depicted, system 500 shows an example for three qubits 510A-C that can use Euler angle rotations (e.g., Ry, Rz, Ry, or Ry, Rx) to fill a Bloch sphere with different possible rotation values, and attempt to avoid overlap between different data points with different feature values leading to different rotations. In the example depicted, density 3 encoding can be followed by full entanglement and 3 more rotations, e.g., 3 qubits×3 rotations×2 repetitions equals 18 features that can be encoded with just 3 qubits.

FIG. 6 illustrates a block diagram of an example system 600 that can facilitate utilizing a quantum transformation to generate a transformed dataset from an original dataset and a quantum feature map, in accordance with one or more embodiments described herein. Repetitive description of like elements employed in one or more embodiments described herein is omitted for sake of brevity.

As depicted, system 600 shows inputs 610, for each data point xᵢ being used to combine multiple iterations of quantum feature transformation, resulting in transformed dataset 660, e.g., via quantum feature transformers 620A-N and classical transformers 630A-N. In this example, by repeating the quantum transformation mapping process (e.g., quantum feature transformer processes 620A-N), shallower quantum circuits can be utilized and thus difficulties inherent in quantum processing can be reduced. Stated differently, one or more embodiments can enable the use of shallower circuits for each step and/or layer, while still facilitating combinations that can create a more complex transformations via multiple iterations.

For example, layering in different ways can be used to combine with the original features/classical transformation, e.g., such as utilizing residual connections to adjust features (sum with original features and normalize), and a simple linear mapping of the outputs to a new transformed set of features, i.e., a classical transformer, trained by greedily optimizing the outputs' current alignment with the targets. In this example, one or more embodiments avoid the end-to-end training of neural network models and/or gradient computation for the circuits, e.g., these being comparatively costly for quantum machine learning approaches.

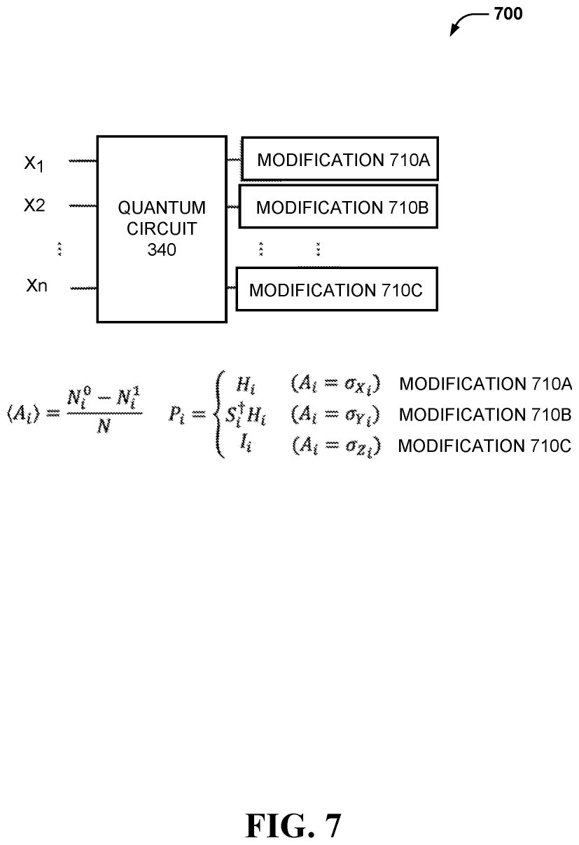

FIG. 7 illustrates a block diagram of an example system 700 that can facilitate utilizing a quantum transformation to generate a transformed dataset from an original dataset and a quantum feature map, in accordance with one or more embodiments described herein. Repetitive description of like elements employed in one or more embodiments described herein is omitted for sake of brevity.

System 700 depicts quantum circuit 340 being transformed by inputs x₁ . . . xₙ. In this example, before being measured as transformed feature measurements (e.g., observables 345A-N) as discussed with FIG. 3 above, the transformations are modified by applying different quantum gates to the qubits, e.g., modifications 710A-C. In this approach, different quantum state features can be modified with different approaches, and by doing so, different sets of observables or measurements can be computed across and for all qubits simultaneously in the same circuit run, thereby avoiding having to run many quantum circuits to get all observable measurements, e.g., reducing the number of circuit runs required from the number of qubits to some small constant number.

For example, as shown in Pi formulas, for the expected values of the observables (Aᵢ), modification 710A utilizes a Hadamard gate (Hᵢ) to alter the results of quantum circuit 340, modification 710B utilizes a phase gate (Sᵢ), and modification 710C is a control, with no modification applied (Iᵢ). In this way, a set of observable measurements can be derived for all qubits using resulting statistics from multiple shots of shared circuit runs, as given by equations for (Aᵢ), where (Ni) are counts of each single qubit state (0 or 1) and N is the number of shots (repeated runs of the same circuit).

In other embodiments, different classical transformations can be applied to the input initial classical dataset 312 before applying quantum feature transformations to each, and these transformed datasets can then be used in conjunction with the original classification data set for machine learning models in different ways. In one example embodiment, the classical machine learning model can select which transformed dataset to use at each iteration of training the classical machine learning model, such as a boosting machine learning model. Selecting which dataset to use can be based on different factors, including which dataset gives the best fit to the current objective of the classical machine learning model at the current iteration.

As another example, models trained on each of the transformed datasets can be combined by an additional classical machine learning model that can learn how to combine the outputs of models applied to each dataset, e.g., to create the best combined output result for a given objective, such as prediction accuracy. As a particular example of the preliminary classical transformations, random subsets of the features (random samples of the set of features for each xᵢ) can be taken as the classical transformation and these can be combined with different randomly selected quantum feature maps, and with different classical modeling, as described above. In this way, fewer features can be applied in each individual feature map, thereby facilitating better outcomes with quantum hardware limitations, and implicitly performing feature selection for initial classical features 312. Additionally, this can also enable implicitly selecting appropriate feature maps for the data and overcoming the issue of, when selecting only a single, particular feature map to use, potential arbitrariness of quantum feature map 315.

In additional or alternative approaches, random observables can be used, as well as auto-tuning of which sets of observables yield the best results. Additional or alternative embodiments can extend decision trees to facilitate different results, e.g., a model based on quantum feature transformations that can be used by one or more embodiments to determine how to split at each point in a decision tree, with potentially a different model being utilized at each step or branch and/or leaf node based on selecting to use the quantum-transformed or original classical features.

In additional or alternative approaches, determining which observables to use, as well as the sequence of transformations to use, can be based on the input training data, e.g., finding/optimizing what observables and transformations to use can be based on what can yield particular results for the given dataset, given a target performance metric. For example, given a goal to maximize the accuracy of predictions of labels for particular input features, one or more embodiments can automatically select the observables to use, and the sequence of transformations to use (e.g., potentially including the parameters of classical transformations in the sequence), such that the expected accuracy of predictions is improved. One or more embodiments can perform these processes with different optimization algorithms, e.g., a greedy layer-wise approach can be used where one transformation at a time can be optimized.

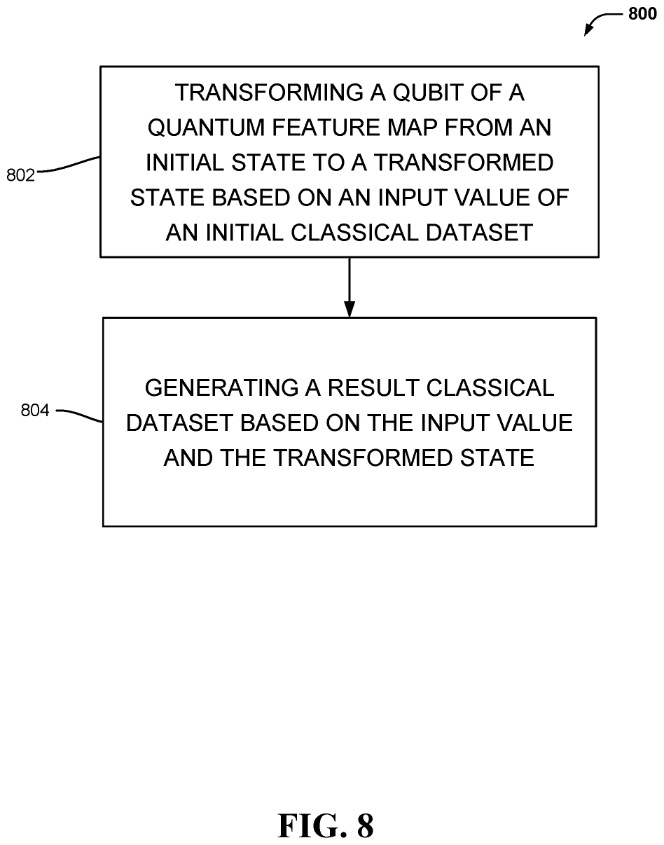

FIG. 8 illustrates a flow diagram of an example, non-limiting computer-implemented method 800 that can facilitate utilizing a quantum transformation to generate a transformed dataset from an original dataset and a quantum feature map, in accordance with one or more embodiments described herein. Repetitive description of like elements and processes employed in respective embodiments is omitted for sake of brevity.

At 802, computer-implemented method 800 can include transforming a qubit of a quantum feature map from an initial state to a transformed state based on an input value of an initial classical dataset. At 804, computer-implemented method 800 can further include generating a result classical dataset based on the input value and the transformed state.

FIG. 9 depicts an example 900 computer-program product (CPP) that can include executable instructions that, when executed by a processor of a system, can facilitate generating a result classical dataset based on an initial classical dataset and a quantum feature map, in accordance with one or more embodiments. For purposes of brevity, description of like elements and/or processes employed in other embodiments is omitted.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more components of computer program instructions, encoded on computer storage medium for execution by, or to control the operation of, information/data processing apparatus. Alternatively, or in addition, the program instructions can be encoded on an artificially generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

In one or more embodiments, the computer program product can include a computer readable storage medium 910 having program instructions embodied therewith, the program instructions being executable by a processor to cause the processor to perform example operations 902 and 904, described below. In one or more embodiments, operation 902 of FIG. 9 can transform a qubit of a quantum feature map from an initial state to a transformed state based on an input value of a first classical dataset. In one or more embodiments, operation 904 of FIG. 9 can generate a second classical dataset based on the input value and the transformed state.

In order to provide a context for the various aspects of the disclosed subject matter, FIG. 10 is intended to provide a general description of a suitable environment in which the various aspects of the disclosed subject matter can be implemented. FIG. 10 illustrates a block diagram of an example, non-limiting operating environment in which one or more embodiments described herein can be facilitated. Repetitive description of like elements employed in other embodiments described herein is omitted for sake of brevity.

Various aspects of the present disclosure are described by narrative text, flowcharts, block diagrams of computer systems and/or block diagrams of the machine logic included in CPP embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

FIG. 10 includes computing environment 1000 as an example of an environment for the execution of at least some of the computer code involved in performing the methods described herein, such as implementation of a transforming component (e.g., transforming component 132) by transform component execution code 1080. In addition to block 1080, computing environment 1000 includes, for example, computer 1001, wide area network (WAN) 1002, end user device (EUD) 1003, remote server 1004, public cloud 1005, and private cloud 1006. In this embodiment, computer 1001 includes processor set 1010 (including processing circuitry 1020 and cache 1021), communication fabric 1011, volatile memory 1012, persistent storage 1013 (including operating system 1022 and block 1080, as identified above), peripheral device set 1014 (including user interface (UI), device set 1023, storage 1024, and Internet of Things (IoT) sensor set 1025), and network module 1015. Remote server 1004 includes remote database 1030. Public cloud 1005 includes gateway 1040, cloud orchestration module 1041, host physical machine set 1042, virtual machine set 1043, and container set 1044.

COMPUTER 1001 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1030. As is well understood in the art of computer technology, and depending upon the technology, performance of a computer-implemented method may be distributed among multiple computers and/or between multiple locations. On the other hand, in this presentation of computing environment 1000, detailed discussion is focused on a single computer, specifically computer 1001, to keep the presentation as simple as possible. Computer 1001 may be located in a cloud, even though it is not shown in a cloud in FIG. 10. On the other hand, computer 1001 is not required to be in a cloud except to any extent as may be affirmatively indicated.

PROCESSOR SET 1010 includes one, or more, computer processors of any type now known or to be developed in the future. Processing circuitry 1020 may be distributed over multiple packages, for example, multiple, coordinated integrated circuit chips. Processing circuitry 1020 may implement multiple processor threads and/or multiple processor cores. Cache 1021 is memory that is located in the processor chip package(s) and is typically used for data or code that should be available for rapid access by the threads or cores running on processor set 1010. Cache memories are typically organized into multiple levels depending upon relative proximity to the processing circuitry. Alternatively, some, or all, of the cache for the processor set may be located “off chip.” In some computing environments, processor set 1010 may be designed for working with qubits and performing quantum computing.

Computer readable program instructions are typically loaded onto computer 1001 to cause a series of operational steps to be performed by processor set 1010 of computer 1001 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1021 and the other storage media discussed below. The program instructions, and associated data, are accessed by processor set 1010 to control and direct performance of the inventive methods. In computing environment 1000, at least some of the instructions for performing the inventive methods may be stored in block 1080 in persistent storage 1013.

COMMUNICATION FABRIC 1011 are the signal conduction paths that allow the various components of computer 1001 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1012 is any type of volatile memory now known or to be developed in the future. Examples include dynamic type random access memory (RAM) or static type RAM. Typically, the volatile memory is characterized by random access, but this is not required unless affirmatively indicated. In computer 1001, the volatile memory 1012 is located in a single package and is internal to computer 1001, but, alternatively or additionally, the volatile memory may be distributed over multiple packages and/or located externally with respect to computer 1001.

PERSISTENT STORAGE 1013 is any form of non-volatile storage for computers that is now known or to be developed in the future. The non-volatility of this storage means that the stored data is maintained regardless of whether power is being supplied to computer 1001 and/or directly to persistent storage 1013. Persistent storage 1013 may be a read only memory (ROM), but typically at least a portion of the persistent storage allows writing of data, deletion of data and re-writing of data. Some familiar forms of persistent storage include magnetic disks and solid-state storage devices. Operating system 1022 may take several forms, such as various known proprietary operating systems or open-source Portable Operating System Interface type operating systems that employ a kernel. The code included in block 1080 typically includes at least some of the computer code involved in performing the inventive methods.

PERIPHERAL DEVICE SET 1014 includes the set of peripheral devices of computer 1001. Data communication connections between the peripheral devices and the other components of computer 1001 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1023 may include components such as a display screen, speaker, microphone, wearable devices (such as goggles and smart watches), keyboard, mouse, printer, touchpad, game controllers, and haptic devices. Storage 1024 is external storage, such as an external hard drive, or insertable storage, such as an SD card. Storage 1024 may be persistent and/or volatile. In some embodiments, storage 1024 may take the form of a quantum computing storage device for storing data in the form of qubits. In embodiments where computer 1001 is required to have a large amount of storage (for example, where computer 1001 locally stores and manages a large database) then this storage may be provided by peripheral storage devices designed for storing very large amounts of data, such as a storage area network (SAN) that is shared by multiple, geographically distributed computers. IoT sensor set 1025 is made up of sensors that can be used in Internet of Things applications. For example, one sensor may be a thermometer and another sensor may be a motion detector.

NETWORK MODULE 1015 is the collection of computer software, hardware, and firmware that allows computer 1001 to communicate with other computers through WAN 1002. Network module 1015 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1015 are performed on the same physical hardware device. In other embodiments (for example, embodiments that utilize software-defined networking (SDN)), the control functions and the forwarding functions of network module 1015 are performed on physically separate devices, such that the control functions manage several different network hardware devices. Computer readable program instructions for performing the inventive methods can typically be downloaded to computer 1001 from an external computer or external storage device through a network adapter card or network interface included in network module 1015.

WAN 1002 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1003 is any computer system that is used and controlled by an end user (for example, a customer of an enterprise that operates computer 1001), and may take any of the forms discussed above in connection with computer 1001. EUD 1003 typically receives helpful and useful data from the operations of computer 1001. For example, in a hypothetical case where computer 1001 is designed to provide a recommendation to an end user, this recommendation would typically be communicated from network module 1015 of computer 1001 through WAN 1002 to EUD 1003. In this way, EUD 1003 can display, or otherwise present, the recommendation to an end user. In some embodiments, EUD 1003 may be a client device, such as thin client, heavy client, mainframe computer, desktop computer and so on.

REMOTE SERVER 1004 is any computer system that serves at least some data and/or functionality to computer 1001. Remote server 1004 may be controlled and used by the same entity that operates computer 1001. Remote server 1004 represents the machine(s) that collect and store helpful and useful data for use by other computers, such as computer 1001. For example, in a hypothetical case where computer 1001 is designed and programmed to provide a recommendation based on historical data, then this historical data may be provided to computer 1001 from remote database 1030 of remote server 1004.

PUBLIC CLOUD 1005 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 1005 is performed by the computer hardware and/or software of cloud orchestration module 1041. The computing resources provided by public cloud 1005 are typically implemented by virtual computing environments that run on various computers making up the computers of host physical machine set 1042, which is the universe of physical computers in and/or available to public cloud 1005. The virtual computing environments (VCEs) typically take the form of virtual machines from virtual machine set 1043 and/or containers from container set 1044. It is understood that these VCEs may be stored as images and may be transferred among and between the various physical machine hosts, either as images or after instantiation of the VCE. Cloud orchestration module 1041 manages the transfer and storage of images, deploys new instantiations of VCEs and manages active instantiations of VCE deployments. Gateway 1040 is the collection of computer software, hardware, and firmware that allows public cloud 1005 to communicate through WAN 1002.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1006 is similar to public cloud 1005, except that the computing resources are only available for use by a single enterprise. While private cloud 1006 is depicted as being in communication with WAN 1002, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1005 and private cloud 1006 are both part of a larger hybrid cloud.

What is claimed is:

1. A system comprising:
a memory that stores computer-executable components; and
a processor, operatively coupled to the memory, that executes the computer-executable components stored in the memory, wherein the computer-executable components comprise:
a transforming component that transforms a qubit of a quantum feature map from an initial state to a transformed state based on an input value of a first classical dataset, and
a dataset component that generates a second classical dataset based on the input value and the transformed state.

2. The system of claim 1, wherein the computer-executable components further comprise a training component that trains a classical machine learning model based on the second classical dataset.

3. The system of claim 2, wherein the input value comprises a first input value, wherein the training component further transforms the qubit of the quantum feature map from the transformed state to a further transformed state based on a second input value of the second classical dataset, and wherein the dataset component further generates a third classical dataset based on the second input value and the further transformed state.

4. The system of claim 3, wherein the quantum feature map comprises mappings of a first feature of the input value and a second feature of the input value, and wherein the transformed state comprises a first observable based on the first feature and a second observable based on the second feature.

5. The system of claim 4, wherein the transformed state comprises a stacking of the first observable and the second observable.

6. The system of claim 4, wherein the dataset component generates the second classical dataset based on:
a first iteration that transforms the second classical dataset based on the first observable, and
a second iteration that transforms the second classical dataset based on the second observable.

7. The system of claim 1, wherein the transformed state comprises a first transformed state, wherein the qubit comprises a first qubit, wherein the quantum feature map comprises a first quantum feature map, wherein the input value comprises a first input value, wherein the dataset component generates the second classical dataset further based on a second input value and a second transformed state of a second qubit of a second quantum feature map, and wherein the second transformed state was transformed based on the second input value of the first classical dataset.

8. The system of claim 1, wherein the quantum feature map is based on the first classical dataset.

9. The system of claim 1, wherein the transforming component transforms the qubit of the quantum feature map to the transformed state further based on application of a quantum gate.

10. The system of claim 9, wherein the quantum gate comprises a Hadamard gate.

11. The system of claim 9, wherein the quantum gate comprises a phase gate.

12. A computer-implemented method, comprising:
transforming, by a device operatively coupled to a processor, a qubit of a quantum feature map from an initial state to a transformed state based on an input value of a first classical dataset; and
generating, by the device, a second classical dataset based on the input value and the transformed state.

13. The computer-implemented method of claim 12, further comprising training a classical machine learning model based on the second classical dataset.

14. The computer-implemented method of claim 12, wherein the quantum feature map comprises mappings of a first feature of the input value and a second feature of the input value, and wherein the transformed state comprises a first observable based on the first feature and a second observable based on the second feature.

15. The computer-implemented method of claim 14, wherein generating the second classical dataset comprises:
a first iteration that transforms the second classical dataset based on the first observable, and
a second iteration that transforms the second classical dataset based on the second observable.

16. The computer-implemented method of claim 12, wherein the transformed state comprises a first transformed state, wherein the qubit comprises a first qubit, wherein the quantum feature map comprises a first quantum feature map, wherein the input value comprises a first input value, wherein generating the second classical dataset is further based on a second input value and a second transformed state of a second qubit of a second quantum feature map, and wherein the second transformed state was transformed based on the second input value of the first classical dataset.

17. A computer program product that generates a result classical dataset based on an initial classical dataset and a quantum feature map, the computer program product comprising a computer readable storage medium having program instructions embodied therewith, the program instructions executable by a processor to cause the processor to:
transform a qubit of the quantum feature map from an initial state to a transformed state based on an input value of the initial classical dataset; and
generate the result classical dataset based on the input value and the transformed state.

18. The computer program product of claim 17, further comprising program instructions to train a classical machine learning model based on the result classical dataset.

19. The computer program product of claim 18, further comprising program instructions to train the classical machine learning model based on the initial classical dataset.

20. The computer program product of claim 19, wherein the quantum feature map comprises mappings of a first feature of the input value and a second feature of the input value, and wherein the transformed state comprises a first observable based on the first feature and a second observable based on the second feature.
